(19) United States
(12) Patent Application Publication
(10) Pub. No.: US 2024/0295897 A1
(43) Pub. Date: Sep. 5, 2024

(54) MULTIPLICATION ABACUS DEVICE

(71) Applicant: JINZHOU MENGZAI STATIONERY SALES CO., LTD., Shijiazhuang (CN)

(72) Inventor: CHAOMENG LIU, Shijiazhuang (CN)

(21) Appl. No.: 18/662,231

(22) Filed: May 13, 2024

Related U.S. Application Data
(63) Continuation of application No. PCT/CN2023/078101, filed on Feb. 24, 2023.

(30) Foreign Application Priority Data
Mar. 24, 2022 (CN) 202220676989.8

(51) Int. Cl. G06C 1/00

(52) U.S. Cl. CPC G06C 1/00

(57) ABSTRACT

A multiplication abacus device is provided, which includes a main body with a result display area, where the result display area has calculation result bits arranged in a matrix, the calculation result bits have numbers for displaying a calculation result, a plurality of sliding members, arranged in a matrix that can slide horizontally and longitudinally on the main body, and located on the calculation result bits, where adjacent M rows of sliding members slide longitudinally, and adjacent N columns of sliding members slide horizontally. After the sliding members do not obstruct one row of calculation result bits and do not obstruct one column of calculation result bits, a number of the calculation result bits in a crossed position is a calculation result of M×N. Through the above technical solution, a technical problem of learning multiplication in existing technologies being abstract and not intuitive enough has been solved.

### CROSS-REFERENCE TO RELATED APPLICATIONS

This application is a continuation of International Application No. PCT/CN2023/078101, filed on Feb. 24, 2023, which claims priority to Chinese Patent Application No. 202220676989.8, filed on Mar. 24, 2022, both of which are hereby incorporated by reference in their entireties.

### TECHNICAL FIELD

The present disclosure relates to the field of multiplication learning tools technologies, and in particular, to a multiplication abacus device.

### BACKGROUND

Multiplication refers to a shortcut way of adding up identical numbers. The result of an operation is called product, and “x” is a multiplication sign. From a philosophical perspective, multiplication is a qualitative result of a quantitative change in addition. The multiplication of integers (including negative numbers), rational numbers (fractions), and real numbers is defined by a system generalization of this basic definition.

Multiplication is one of the four fundamental operations and is a very important fundamental operation in arithmetic. Multiplication can also be considered as computing objects arranged in rectangles (integers) or finding regions of rectangles with given edge lengths. The rectangular area does not depend on which edge is measured first, which indicates the exchange of attributes. The product of two measurements is a new type of measurement, for example, multiplying the lengths of two edges of a rectangle to give its area, which is a theme of size analysis.

The learning of multiplication starts from elementary school. For primary school students in grades one and two, after learning addition and subtraction operations, they will continue to learn multiplication because it is very different from addition and subtraction operations, rendering it difficult to quickly become familiar with them. For primary school students, multiplication formulas are considered abstract and not intuitive enough. Although there are specialized cards with a multiplication table to help with memory, learning multiplication is also quite difficult. It all depends on rote memorization to remember, and indeed, if you memorize more, you can still remember. However, it cannot fundamentally understand and memory. Therefore, for other calculations based on multiplication, learning and mastering them is difficult to fundamentally understand, and can only rely on rote memorization, which is not conducive to an establishment of mathematical thinking in primary school students.

### SUMMARY

The present disclosure proposes a multiplication abacus device, which solves a problem of using a multiplication table to learn multiplication in related technologies, which is somewhat abstract and not intuitive enough.

The technical solution of the present disclosure is as follows.

A multiplication abacus device, including:
a main body having a result display area that can be detachable and combined, the result display area has calculation result bits arranged in a matrix and the calculation result bits have numbers for displaying a calculation result on the calculation result bits,
a plurality of sliding members arranged in a matrix, which are sliding horizontally and longitudinally on the main body and located on the calculation result bits,
where adjacent M rows of sliding member slide longitudinally, and adjacent N columns of sliding member slide longitudinally; a number of the calculation result bits in a crossed position is a calculation result of M×N after the sliding member do not obstruct one row of the calculation result bits and do not obstruct one column of the calculation result bits.

In an embodiment,
the main body includes a row number indication area, which has a column of row number display bits with numbers for displaying row number on the row number display bits,
the main body further includes a column number indication area, which has a row of column number display bits with numbers for displaying column number on the column number display bits.

In an embodiment,
a horizontal bar, each row of sliding member is horizontally and slidably provided on one of the horizontal bar, each horizontal bar is longitudinally and slidably provided on the main body,
a longitudinal bar, each column of sliding member is longitudinally and slidably provided on one of the longitudinal bar, each longitudinal bar is horizontally and slidably provided on the main body.

In an embodiment,
a longitudinal guide rod that is longitudinally provided on the main body,
there are several longitudinal sliding sleeves longitudinally and slidably provided on the longitudinal guide rod, each horizontal bar is provided on a corresponding longitudinal sliding sleeve,
a horizontal guide rod that is horizontally provided on the main body,
there are several horizontal sliding sleeves horizontally and slidably provided on the horizontal guide rod, each longitudinal bar is provided on a corresponding horizontal sliding sleeve.

In an embodiment,
each sliding member has a horizontal channel and a longitudinal channel, the horizontal bar passes through the horizontal channel, and the longitudinal bar passes through the longitudinal channel,
the horizontal channel and the longitudinal channel are perpendicular to each other so that the horizontal bar and the longitudinal bar are caused to be staggered in height on the sliding members.

In an embodiment, the calculation result bits arranged in a matrix is a 9×9 matrix, 10×10 matrix, 19×19 matrix, or 20×20 matrix,
the sliding members arranged in a matrix is a 9×9 matrix, 10×10 matrix, 19×19 matrix, or 20×20 matrix,
M and N are natural numbers.

In an embodiment,
when the sliding members arranged in a matrix is a 19×19 matrix or a 20×20 matrix, a spacer is provided between the sliding member in an eleventh column and the sliding member in a tenth column, and between the sliding member in an eleventh row and the sliding member in a tenth row; the horizontal bar and the longitudinal bar pass through the spacer.

In an embodiment, when the calculation result bits arranged in a matrix is a 10×10 matrix and the sliding members arranged in a matrix is a 10×10 matrix, the number of the calculation result bits arranged in a matrix is displayed in the following arrangement:

$$[ \begin{matrix}10 & 20 & 30 & 40 & 50 & 60 & 70 & 80 & 90 & 100 \\ 9 & 18 & 27 & 36 & 45 & 54 & 63 & 72 & 81 & 90 \\ 8 & 16 & 24 & 32 & 40 & 48 & 56 & 64 & 72 & 80 \\ 7 & 14 & 21 & 28 & 35 & 42 & 49 & 56 & 63 & 70 \\ 6 & 12 & 18 & 24 & 30 & 36 & 42 & 48 & 54 & 60 \\ 5 & 10 & 15 & 20 & 25 & 30 & 35 & 40 & 45 & 50 \\ 4 & 8 & 12 & 16 & 20 & 24 & 28 & 32 & 36 & 40 \\ 3 & 6 & 9 & 12 & 15 & 18 & 21 & 24 & 27 & 30 \\ 2 & 4 & 6 & 8 & 10 & 12 & 14 & 16 & 18 & 20 \\ 1 & 2 & 3 & 4 & 5 & 6 & 7 & 8 & 9 & 10\end{matrix} ] .$$

In an embodiment, when the calculation result bits arranged in a matrix is a 20×20 matrix and the sliding member arranged in a matrix is a 20×20 matrix, the number of the calculation result bits arranged in a matrix is displayed in the following arrangement:

$$[ \begin{matrix}20 & 40 & 60 & … & 360 & 380 & 400 \\ 19 & 38 & 57 & … & 342 & 361 & 380 \\ 18 & 36 & 54 & … & 324 & 342 & 360 \\ ⋮ & ⋮ & ⋮ & ⋱ & ⋮ & ⋮ & ⋮ \\ 3 & 6 & 9 & … & 54 & 57 & 60 \\ 2 & 4 & 6 & … & 36 & 38 & 40 \\ 1 & 2 & 3 & … & 18 & 19 & 20\end{matrix} ] .$$

The working principle and beneficial effects of the present disclosure are:
1. It is able to directly demonstrate and calculate the product of two numerical values.
2. It can simultaneously connect the horizontal axes and longitudinal axe and slide in two directions on a tray.
3. It is possible to quickly obtain the product of two numbers by moving the sliding member and a product matrix on the calculation result bits of the main body.
4. It can quickly calculate and demonstrate the product of any two numbers between 11 and 19 by setting the color of the sliding member and fixed mnemonics.
5. It can be easily operated and carried, and better understand the concept of multiplication.
6. This device can assist students in learning multiplication, quickly understanding the concept of multiplication and easily remembering the corresponding product through a combination of hand, brain, and eye modes; no more rote memorization is required, and can easily understand and directly see the things represented by the product.
7. This device can assist students in enhancing their reasoning ability when learning multiplication, remember 6×7=42, think of pulling out another row of 7 beads, 42+7=49 if do not clearly remember 7×7=what.
8. Through multiple systematic uses of this device, students can exercise their spatial thinking and mathematical modeling abilities, and understand multiplication calculations from a perspective of “area”.
9. This device breaks a boundary of sliding in a single axis in an overall structure, pioneering an application of a structure controlling bead in two axis in digital calculation teaching aids, which saves space and increase students' interest in learning.

### BRIEF DESCRIPTION OF DRAWINGS

Below, a further detailed explanation of the present disclosure will be provided in combination with the accompanying drawings and specific embodiment.

FIG. 1 is a structural schematic diagram of an embodiment of the present disclosure.

FIG. 2 is a structural schematic diagram of a result display area in an embodiment of the present disclosure.

FIG. 3 is a structural schematic diagram during calculation in an embodiment of the present disclosure.

FIG. 4 is a structural schematic diagram of another embodiment of the present disclosure.

FIG. 5 is a structural three-dimensional diagram of an embodiment of the present disclosure.

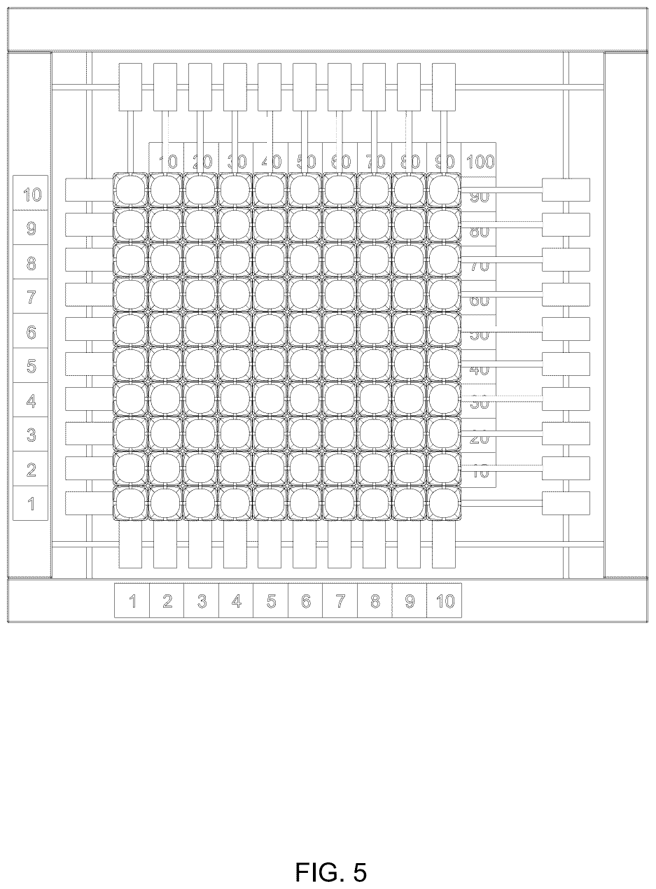

FIG. 6 is a structural three-dimensional diagram when calculating 4×6 in an embodiment of the present disclosure.

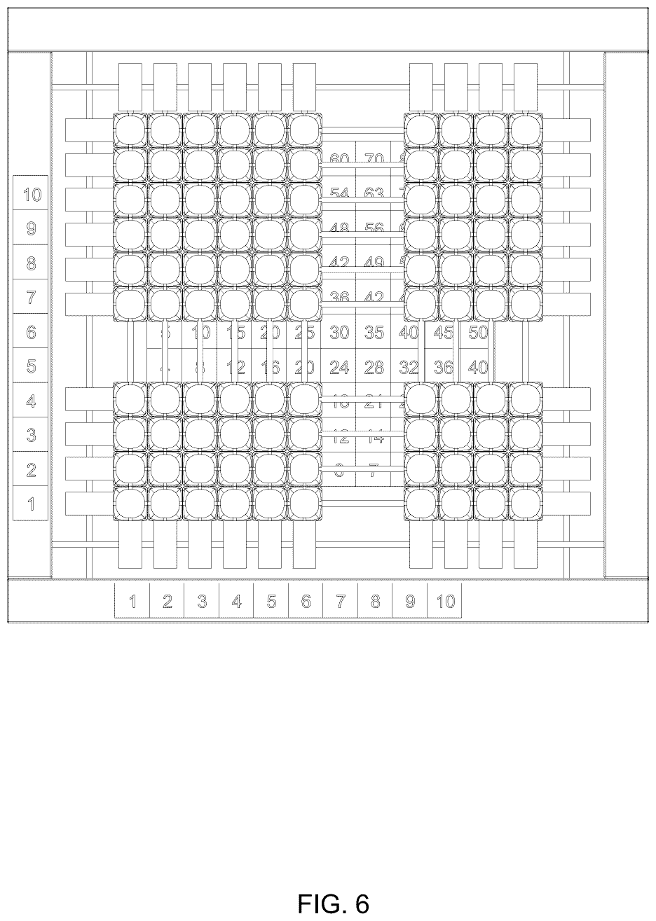

FIG. 7 is a structural three-dimensional diagram with the result display area in an embodiment of the present disclosure.

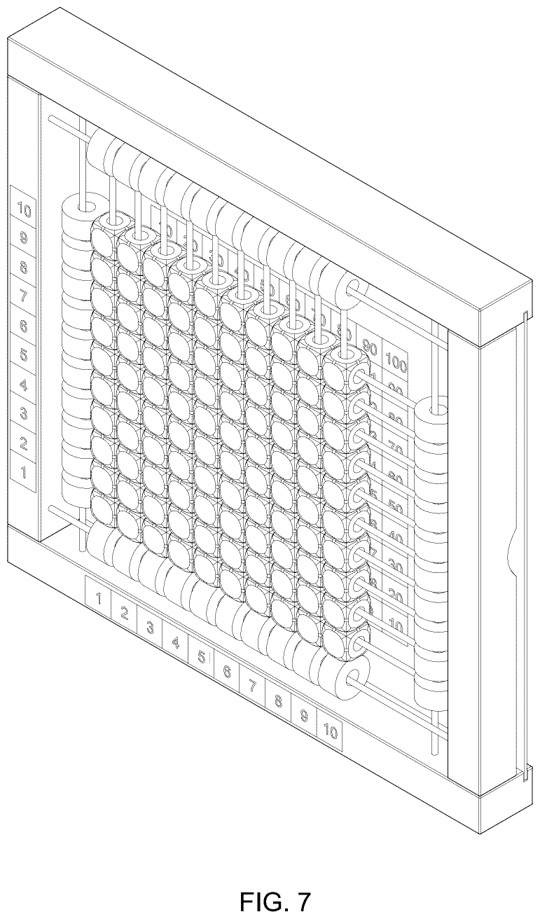

FIG. 8 is a structural three-dimensional diagram that the result display area is pulled out in an embodiment of the present disclosure.

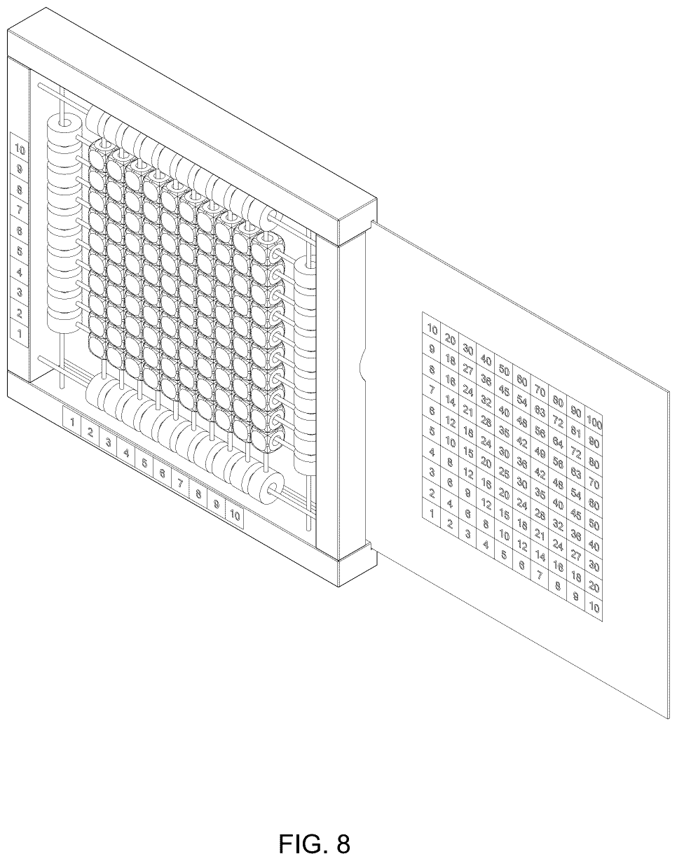

Numeral reference: Main body (1), result display area (101), calculation result bits (102), row number indication area (103), row number display bits (104), column number indication area (105), column number display bits (106), sliding member (2), horizontal channel (201), longitudinal channel (202), horizontal bar (3), longitudinal bar (4), longitudinal guide rod (5), longitudinal sliding sleeve (6), horizontal guide rod (7), horizontal sliding sleeve (8), spacer (9).

### DESCRIPTION OF EMBODIMENTS

The following will provide a clear and complete description of the technical solution in the embodiments of the present disclosure, in combination with the embodiments of the present disclosure. Obviously, the described embodiments are only a part of the embodiments of the present disclosure, not all of them. Based on the embodiments in the present disclosure, all other embodiments obtained by those skilled in the art without creative work involve the protection scope of the present disclosure.

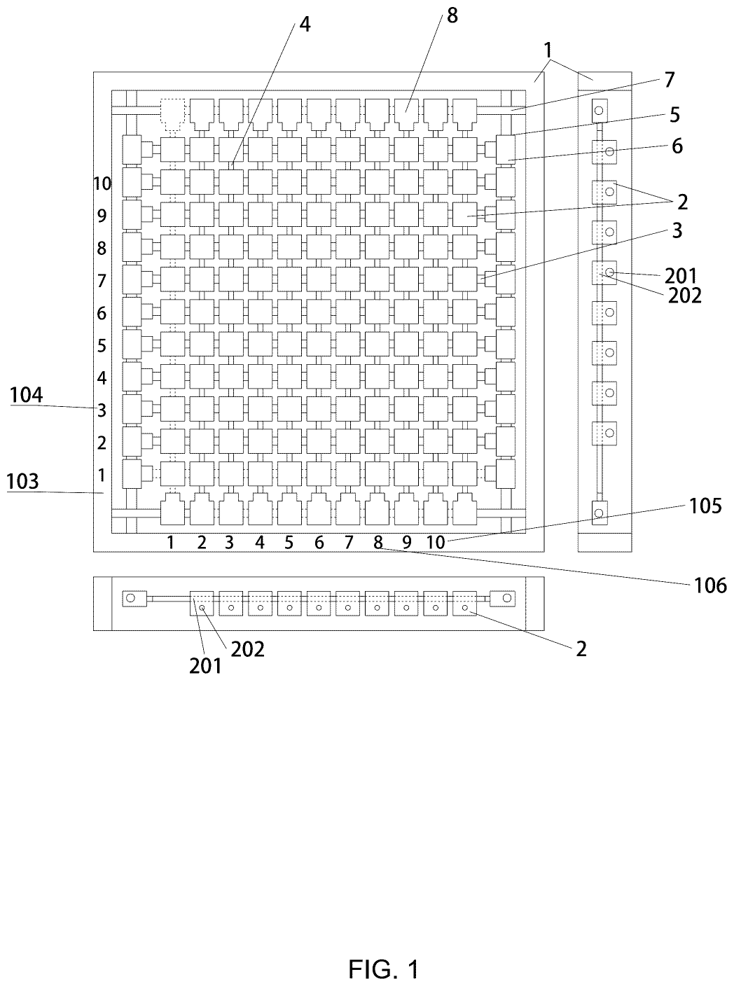

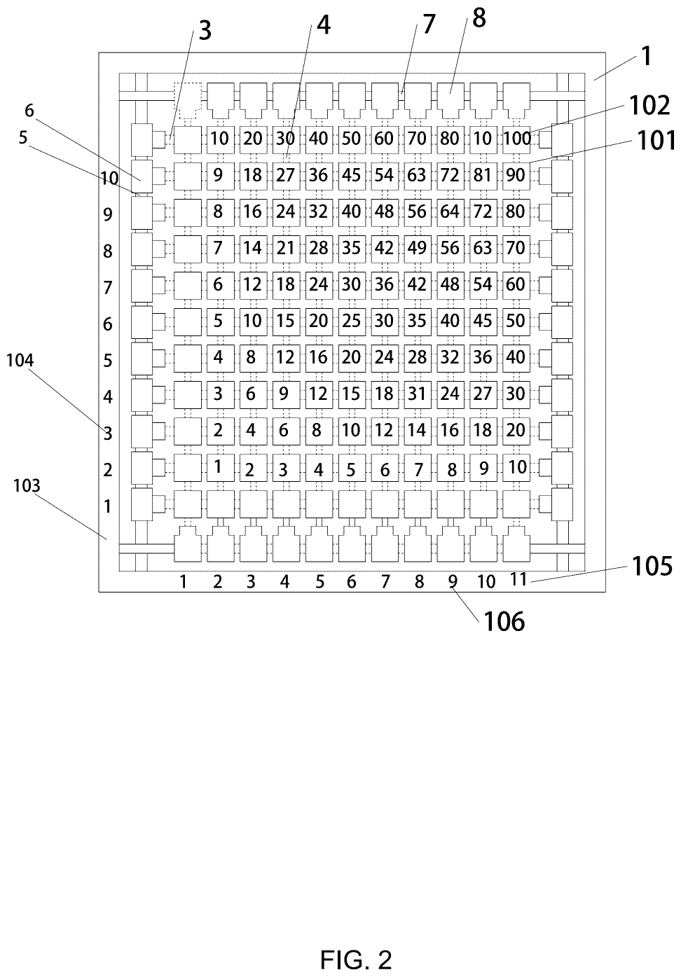

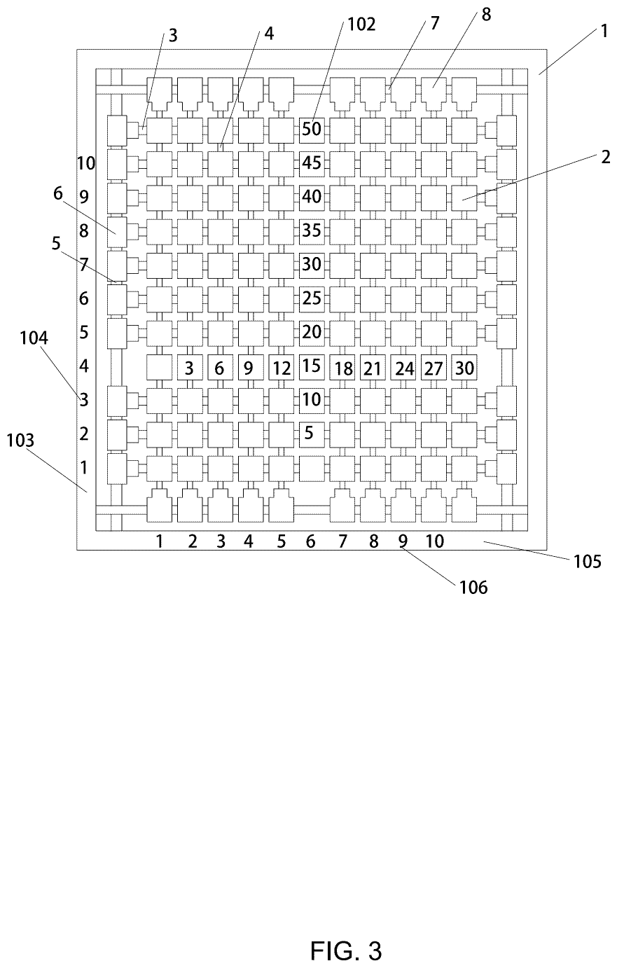

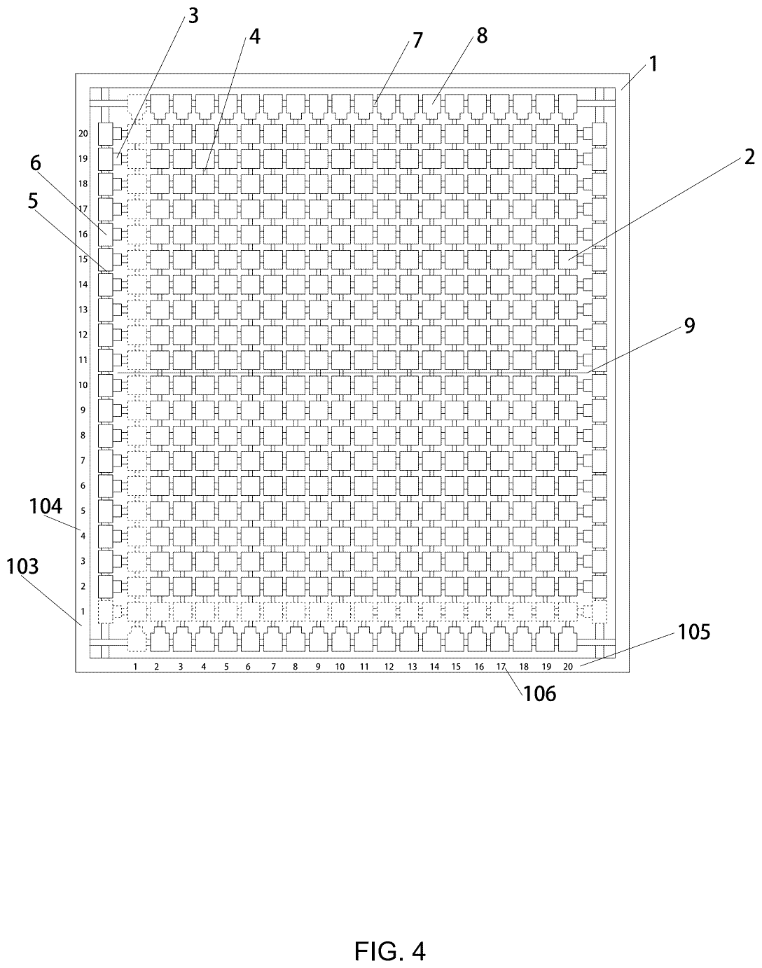

As shown in FIGS. 1 to 4, an embodiment proposes a multiplication abacus device, including:
a main body 1 having a result display area 101 that can be disassembled and combined, the result display area 101 has calculation result bits 102 arranged in a matrix, on which there are numbers used to display a calculation result,
a plurality of sliding members 2 arranged in a matrix, which can slide horizontally and longitudinally on the main body 1, and is also located on the calculation result bits 102,
where adjacent M rows of sliding members 2 slide longitudinally, adjacent N columns of sliding members 2 slide longitudinally; a number of the calculation result bits 102 in a crossed positon is a calculation result of M×N when the sliding members 2 do not obstruct one row of calculation result bits 102 and do not obstruct one column of calculation result bits 102.

In this embodiment, considering that primary school students in their first or second year are now learning multiplication by carrying a multiplication mnemonic card back and forth, which is not only laborious but also difficult to fully understand, the inventor has designed a multiplication abacus device specifically for primary school students through continuous research. When learning multiplication, not only can the multiplication results be directly seen, but also an impression can be deepened through hands-on operation to achieve a goal of thorough and intuitive understanding.

Specifically, the multiplication abacus device has the main body 1 for carrying various components, which can be understood as a body of the abacus. The main body 1 is provided with a result display area 101 that can be detachable and combined, and the calculation result bits 102 arranged in a matrix on it are the multiplication calculation results. In order to not see the multiplication calculation results at the beginning, a plurality of sliding members 2 are designed on it to block the calculation results. These sliding members 2 can be understood as beads of the abacus, and are also arranged in a matrix type, which can move horizontally and at the same time move along a longitudinal direction. Generally, for ease of operation, it is best to move an entire row longitudinally and an entire column horizontally. For example, it can be designed that adjacent M rows of sliding members 2 move down longitudinally, while adjacent N columns of sliding members 2 move left longitudinally. The sliding member 2 will not obstruct one row of calculation result bits 102 and will not obstruct one column of calculation result bits 102, the number in the calculation result bits 102 at the crossed position is the calculation result of M×N. An actual calculation example: the entire row are longitudinally moved down by 5 rows, and the entire column are moved left by 8 columns. The sliding members 2 that simultaneously moves down and left is a 5×8 matrix. Therefore, a row of numbers will be exposed above this matrix, and a column of numbers will be exposed to a right of this matrix. There is a number in a crossed positon between this row of numbers with this column of numbers, and the number in the crossed position is the calculation result of 5×8 being 40. Therefore, through the multiplication abacus device in this embodiment, a good visual demonstration of the calculation is achieved. The matrix in a lower left corner of the calculation result is the principle of multiplication calculation, and the calculation result is also displayed intuitively. Throughout the process, there will be an organic combination of student's hands-on operation, process thinking, and direct result display, which achieves the effect of deepening understanding and memory, and can also be conveniently carried.

In an implementation, the main body 1 includes a row number indication area 103, which has a column of row number display bits 104 with numbers for displaying row number on the row number display bits 104.

The main body 1 further includes a column number indication area 105, which has a row of column number display bits 106 with numbers for displaying column number on the column number display bits 106.

In this embodiment, in order to display the number of rows and columns more intuitively, the row number indication area 103 is specially designed, which can be engraved or printed with a column of numbers which display the row number display bits 104. The column number indication area 105 is designed, which can be engraved or printed with a row of numbers which display the column number display bits 106. This allows for quick counting of where to start moving several rows and columns before calculation, and ensures that after the movement is completed, the number of rows and columns will not be forgotten in an instant, thereby resulting in a multiplication calculation of how much was moved and how much was multiplied to achieve a goal of quick calculation. Of course, the row number display bits 104 and column number display bits 106 do not necessarily require printing one column or one row. It is also possible to print two rows located in upper and lower sections of the main body 1, and two columns located at left and right ends of main body 1, rendering it more convenient to move and calculate.

In an implementation, the multiplication abacus device further includes a horizontal bar 3, each row of sliding member 2 is longitudinally and slidably provided on one of the horizontal bar 3, each horizontal bar 3 is longitudinally and slidably provided on the main body 1, a longitudinal bar 4, each column of sliding member 2 is longitudinally and slidably provided on one of the longitudinal bar 4, each longitudinal bar 4 is horizontally and slidably provided on the main body 1.

In this embodiment, in order to facilitate the entire row and column movement of sliding member 2 arranged in a matrix, and achieve fast operation and calculation, a plurality of horizontal bars 3 and a plurality of longitudinal bars 4 are specially designed to pass through the sliding members 2, so that each horizontal bar 3 can move longitudinally and drives a row of sliding members 2 to move at the same time, each sliding member 2 can be moved horizontally driven by a longitudinal bar 4, thereby achieving one longitudinal bar 4 drives one column of sliding member 2 to move entirely, so as to achieve the goal of fast operation and calculation, thereby greatly facilitating the use by primary school students. Compared with the independent sliding of each sliding member 2 in related technologies, it is more suitable for first and second grade students to use.

In an implementation, the multiplication abacus device further includes a longitudinal guide rod 5 that is longitudinally provided on the main body 1, there are several longitudinal sliding sleeves 6 longitudinally and slidably provided on the longitudinal guide rod 5, each horizontal bar 3 is provided on a corresponding longitudinal sliding sleeve 6; a horizontal guide rod 7 that is horizontally provided on the main body 1; there are several horizontal sliding sleeves 8 horizontally and slidably provided on the horizontal guide rod 7, each longitudinal bar 4 is provided on a corresponding horizontal sliding sleeve 8.

In this embodiment, in order to better achieve smooth sliding of sliding member 2, longitudinal sliding sleeves 6 are provided at two ends of each horizontal bar 3, and horizontal sliding sleeves 8 are provided at two ends of each horizontal guide rod 7. The longitudinal sliding sleeves 6 slides on the longitudinal guide rod 5, and the horizontal sliding sleeves 8 slide on horizontal guide rod 7, thereby ensuring a smooth of the entire sliding process, ensuring product quality, meeting the needs of all scenarios, making the product more popular among elementary school students, and achieving the goal of being loved by students. The longitudinal sliding sleeve 6 and the horizontal sliding sleeve 8 can both be connected and guided.

In an implementation, each sliding member 2 has a horizontal channel 201 and a longitudinal channel 202, the horizontal bar 3 passes through horizontal channel 201 and the longitudinal bar 4 passes through the longitudinal channel 202, the horizontal channel 201 and longitudinal channel 202 are perpendicular to each other so that the horizontal bar 3 and longitudinal bar 4 are caused to be staggered in height on the sliding members 2.

In this embodiment, considering that each sliding member 2 needs to slide horizontally on the horizontal bar 3 and longitudinally on the longitudinal bar 4, the horizontal channel 201 and longitudinal channel 202 are provided on the sliding members 2 for guidance. The horizontal channel 201 and the longitudinal channel 202 are perpendicular to each other so that the horizontal bar 3 and the longitudinal bar 4 are caused to be staggered in height on the sliding member 2, rendering it possible for each sliding member 2 to move both horizontally and longitudinally, thereby ensuring a rationality of the product.

In an implementation, the calculation result bits 102 arranged in a matrix is a 9×9 matrix, 10×10 matrix, 19×19 matrix, or 20×20 matrix. The sliding members 2 arranged in a matrix is a 9×9 matrix, 10×10 matrix, 19×19 matrix, or 20×20 matrix, M and N are natural numbers.

In this embodiment, the multiplication abacus device can be designed for both the calculation of 9×9 multiplication, a calculation demonstration of 19×19 multiplication can be also designed, a calculation demonstration of 10×10 and 20×20 internal multiplication can be also designed. If it is designed for the calculation demonstration of multiplication of 19×19 within 19, for the convenience of calculation, the sliding members 2 can be colored, such as a 20×20 matrix containing 4 10×10 matrices, adjacent 10×10 matrices are designed to have different colors.

There are two calculation methods. One is to move several rows and columns of sliding members 2 in an upper right corner, the exposed number in the calculation result bits 102 is the calculation result. The second method is as follows: for example, when calculating 14×15, 14 rows of sliding members 2 are firstly moved downwards, and then 15 columns of sliding members 2 are moved to the left. At this time, the sliding members 2 with a matrix of 14×15, combined with the different colors of the sliding members 2, is divided into four parts. The sliding members 2 in an upper right corner matrix is 4×5=20, and the sliding members 2 in the other three matrix parts are multiples of 10. Therefore, the sliding members 2 in the upper left corner matrix can be replaced and moved to a lower right corner, that is, horizontal 14 rows of sliding members 2 are moved back to 4 rows, and 4 columns of sliding members 2 are added in the 15 rows of sliding members 2, resulting in a total of 190 of sliding members for the 19 rows, that is 190+20=210, which is the calculated result of 14×15.

In an implementation, when the sliding members 2 arranged in a matrix is a 19×19 matrix or a 20×20 matrix, a spacer 9 is provided between the sliding member 2 in an eleventh column and the sliding member 2 in a tenth column, as well as between the sliding members 2 in a eleventh row and the sliding members 2 in a tenth row, the horizontal bar 3 and longitudinal bar 4 pass through the spacer.

In this embodiment, in order to achieve a more convenient and fast calculation, when the sliding member 2 is a 19×19 matrix or a 20×20 matrix, the spacer 9 can be added to meet a distinction between multiplication calculations within 10 and multiplication calculations between 10 and 20, thereby meeting more calculation convenience.

In an implementation, when the calculation result bits 102 arranged in a matrix is a 10×10 matrix, the sliding members 2 arranged in a matrix is a 10×10 matrix, and the number of the calculation result bits 102 arranged in a matrix is displayed in the following arrangement:

$$[ \begin{matrix}10 & 20 & 30 & 40 & 50 & 60 & 70 & 80 & 90 & 100 \\ 9 & 18 & 27 & 36 & 45 & 54 & 63 & 72 & 81 & 90 \\ 8 & 16 & 24 & 32 & 40 & 48 & 56 & 64 & 72 & 80 \\ 7 & 14 & 21 & 28 & 35 & 42 & 49 & 56 & 63 & 70 \\ 6 & 12 & 18 & 24 & 30 & 36 & 42 & 48 & 54 & 60 \\ 5 & 10 & 15 & 20 & 25 & 30 & 35 & 40 & 45 & 50 \\ 4 & 8 & 12 & 16 & 20 & 24 & 28 & 32 & 36 & 40 \\ 3 & 6 & 9 & 12 & 15 & 18 & 21 & 24 & 27 & 30 \\ 2 & 4 & 6 & 8 & 10 & 12 & 14 & 16 & 18 & 20 \\ 1 & 2 & 3 & 4 & 5 & 6 & 7 & 8 & 9 & 10\end{matrix} ] .$$

In this embodiment, when printing or engraving the calculation result bits 102, the above matrix can be used to meet the calculation results required for multiplication within 10×10.

In an implementation, when the calculation result bits 102 arranged in a matrix is a 20×20 matrix, the sliding members 2 arranged in a matrix is a 20×20 matrix, the number of the calculation result bits 102 arranged in a matrix is displayed in the following arrangement:

$$[ \begin{matrix}20 & 40 & 60 & … & 360 & 380 & 400 \\ 19 & 38 & 57 & … & 342 & 361 & 380 \\ 18 & 36 & 54 & … & 324 & 342 & 360 \\ ⋮ & ⋮ & ⋮ & ⋱ & ⋮ & ⋮ & ⋮ \\ 3 & 6 & 9 & … & 54 & 57 & 60 \\ 2 & 4 & 6 & … & 36 & 38 & 40 \\ 1 & 2 & 3 & … & 18 & 19 & 20\end{matrix} ] .$$

In this embodiment, when printing or engraving the calculation result bits 102, the above matrix can be used to meet the calculation results required for multiplication within 20×20.

The above are only preferred embodiments of the present disclosure and are not intended to limit it. Any modifications, equivalent replacements, improvements, etc. made within the spirit and principles of the present disclosure should be included in the scope of protection of the present disclosure.

What is claimed is:

1. A multiplication abacus device, comprises
a main body having a result display area that can be detachable and combined, the result display area has calculation result bits arranged in a matrix and the calculation result bits have numbers for displaying a calculation result on the calculation result bits,
a plurality of sliding members arranged in a matrix, which are sliding horizontally and longitudinally on the main body and located on the calculation result bits,
wherein adjacent M rows of sliding member slide longitudinally, and adjacent N columns of sliding member slide longitudinally; a number of the calculation result bits in a crossed position is a calculation result of M×N after the sliding members do not obstruct one row of the calculation result bits and do not obstruct one column of the calculation result bits.

2. The multiplication abacus device according to claim 1, wherein
the main body comprises a row number indication area, which has a column of row number display bits with numbers for displaying row number on the row number display bits,
the main body further comprises a column number indication area, which has a row of column number display bits with numbers for displaying column number on the column number display bits.

3. The multiplication abacus device according to claim 1, further comprising:
a horizontal bar, each row of sliding member is horizontally and slidably provided on one of the horizontal bar, each horizontal bar is longitudinally and slidably provided on the main body,
a longitudinal bar, each column of sliding member is longitudinally and slidably provided on one of the longitudinal bar, each longitudinal bar is horizontally and slidably provided on the main body.

4. The multiplication abacus device according to claim 3, further comprising:
a longitudinal guide rod that is longitudinally provided on the main body,
there are several longitudinal sliding sleeves longitudinally and slidably provided on the longitudinal guide rod, each horizontal bar is provided on a corresponding longitudinal sliding sleeve,
a horizontal guide rod that is horizontally provided on the main body,
there are several horizontal sliding sleeves horizontally and slidably provided on the horizontal guide rod, each longitudinal bar is provided on a corresponding horizontal sliding sleeve.

5. The multiplication abacus device according to claim 4, wherein
each sliding member has a horizontal channel and a longitudinal channel, the horizontal bar passes through the horizontal channel, and the longitudinal bar passes through the longitudinal channel,
the horizontal channel and the longitudinal channel are perpendicular to each other so that the horizontal bar and the longitudinal bar are caused to be staggered in height on the sliding members.

6. The multiplication abacus device according to claim 1, wherein the calculation result bits arranged in a matrix is a 9×9 matrix, 10×10 matrix, 19×19 matrix, or 20×20 matrix,
the sliding members arranged in a matrix is a 9×9 matrix, 10×10 matrix, 19×19 matrix, or 20×20 matrix,
M and N are natural numbers.

7. The multiplication abacus device according to claim 6, wherein
when the sliding members arranged in a matrix is a 19×19 matrix or a 20×20 matrix, a spacer is provided between the sliding member in an eleventh column and the sliding member in a tenth column, and between the sliding member in an eleventh row and the sliding member in a tenth row; the horizontal bar and the longitudinal bar pass through the spacer.

8. The multiplication abacus device according to claim 6, wherein when the calculation result bits arranged in a matrix is a 10×10 matrix and the sliding members arranged in a matrix is a 10×10 matrix, the number of the calculation result bits arranged in a matrix is displayed in the following arrangement:
$$[ \begin{matrix}10 & 20 & 30 & 40 & 50 & 60 & 70 & 80 & 90 & 100 \\ 9 & 18 & 27 & 36 & 45 & 54 & 63 & 72 & 81 & 90 \\ 8 & 16 & 24 & 32 & 40 & 48 & 56 & 64 & 72 & 80 \\ 7 & 14 & 21 & 28 & 35 & 42 & 49 & 56 & 63 & 70 \\ 6 & 12 & 18 & 24 & 30 & 36 & 42 & 48 & 54 & 60 \\ 5 & 10 & 15 & 20 & 25 & 30 & 35 & 40 & 45 & 50 \\ 4 & 8 & 12 & 16 & 20 & 24 & 28 & 32 & 36 & 40 \\ 3 & 6 & 9 & 12 & 15 & 18 & 21 & 24 & 27 & 30 \\ 2 & 4 & 6 & 8 & 10 & 12 & 14 & 16 & 18 & 20 \\ 1 & 2 & 3 & 4 & 5 & 6 & 7 & 8 & 9 & 10\end{matrix} ] .$$

9. The multiplication abacus device according to claim 6, wherein when the calculation result bits arranged in a matrix is a 20×20 matrix and the sliding member arranged in a matrix is a 20×20 matrix, the number of the calculation result bits arranged in a matrix is displayed in the following arrangement:
$$[ \begin{matrix}20 & 40 & 60 & … & 360 & 380 & 400 \\ 19 & 38 & 57 & … & 342 & 361 & 380 \\ 18 & 36 & 54 & … & 324 & 342 & 360 \\ ⋮ & ⋮ & ⋮ & ⋱ & ⋮ & ⋮ & ⋮ \\ 3 & 6 & 9 & … & 54 & 57 & 60 \\ 2 & 4 & 6 & … & 36 & 38 & 40 \\ 1 & 2 & 3 & … & 18 & 19 & 20\end{matrix} ] .$$
